(19) United States
(12) Patent Application Publication
(10) Pub. No.: US 2010/0293973 A1
(43) Pub. Date: Nov. 25, 2010

(54) Combined cycle exhaust powered turbine inlet air chilling

(76) Inventor: Donald Charles Erickson, Annapolis, MD (US)

Correspondence Address: Donald Erickson, 627 Ridgely Avenue, Annapolis, MD, 21401, US

(21) Appl. No.: 12/799,152

(22) Filed: Apr. 20, 2010

Related U.S. Application Data
(60) Provisional application No. 61/214,119, filed on Apr. 20, 2009.

(51) Int. Cl. F25B 15/00; F02C 7/08

(52) U.S. Cl. 62/101; 62/481; 60/39.5

(57) ABSTRACT

An ammonia absorption refrigeration apparatus is disclosed that has advantageous features to enable it to be integrated with a power plant comprised of a combustion turbine plus a heat recovery steam generator (e.g. a combined cycle plant), in a manner so as to enhance the performance of the power plant. Exhaust heat from the power plant powers the AAR, and refrigeration from the AAR chills the inlet air to the combustion turbine. Thus the power plant output is markedly increased on hot days at high efficiency, with little or no parasitic penalty.

The advantageous features include any or all of: preheating the HRSG feedwater from an absorber of the AAR; distilling the ammonia vapor generated by said exhaust heat (preferably using non-adiabatic distillation); chilling the inlet air in more than one stage, each stage supplied by a different temperature evaporator of the AAR; providing anti-icing heating to the inlet air when needed; providing internal heat recuperation in the AAR via at least one of AHX and GAX; and providing more than one heat input to said AAR at different temperatures, each one via any of: a. HRVG in the exhaust stream; b. recirculated HRSG water; or c. HRSG steam.

### BACKGROUND

Combustion turbines may be fired with natural gas, synthesis gas, low BTU gas, or oil. Each of those fuels may be derived from fossil fuel or biomass fuel. Regardless of the fuel source, almost all combustion turbines suffer a degradation of power output and energy efficiency at warmer ambient temperatures. Accordingly it has become common to chill the inlet air to combustion turbines on warm days. Evaporative cooling has been most commonly used, owing to its low cost. Mechanical compression refrigeration is rapidly gaining market share, especially with peaking applications, because it provides a much larger and more reliable benefit. Thermal chill storage and waste heat powered absorption refrigeration have each found niche applications. Traditional LiBr absorption chillers have suffered from not adapting well to the specific requirements of combustion turbine exhaust powered inlet chilling. Traditional aqua-ammonia absorption refrigeration plants have suffered from being too large and expensive. If those problems can be resolved, waste heat powered absorption refrigeration shows considerable advantage over mechanical compression refrigeration for chilling turbine inlet air, due to the elimination of the large parasitic electric load and several lesser factors (reduced maintenance, more reliability, faster cooldown, smaller/fewer transformers and switchgear, no lube oil system, etc.).

When the combustion turbine exhaust is applied to a heat recovery steam generator (HRSG), e.g. in a combined cycle plant or a cogeneration plant, there is in additional obstacle to adopting the waste heat powered absorption refrigeration plant. It will frequently be competing with the steam users for the waste heat. If too much good quality steam is required by the absorption plant, that parasitic load can be as bad as or worse than the electric parasitic load of mechanical compression. Surprisingly, this is true even for low pressure steam from three pressure cycles, e.g. 50 to 80 psia steam.

Especially with modern combined cycle plants, the heat recovery steam generator has been optimized for the amount of exhaust heat available, using e.g. three pressure levels and reheat, such that the final exhaust temperature is quite low, in the range of 160 F to 210 F. Thus there is seemingly little or no remaining waste heat to power an absorption cycle.

The prior art pertinent to exhaust powered turbine inlet air chilling for combined cycle plants includes: Hoffdorff and Malewski (1986), Ondryas et al (1991), Langreck (Colibri)(2000), Nagib (1971), Carasci et al (2000), Yokoyama and Ito (2000), Sigler et al (2001), Boonnasa et al (2006), Erickson (U.S. Pat. No. 6,584,801), Erickson (U.S. Pat. No. 6,715,290), Erickson (U.S. Pat. No. 6,739,119), Stuhlmuller (U.S. Pat. No. 7,178,348), Pierson (U.S. Pat. No. 7,343,746), and Smith et al (2007/0240400). Additional citations of interest include Nettel (U.S. Pat. No. 2,322,717), Wolfner (U.S. Pat. No. 2,548,508), Foster-Pegg (U.S. Pat. No. 3,796,045), Lehto (U.S. Pat. No. 5,203,161), Holenberger (U.S. Pat. No. 5,444,971), Meckler (U.S. Pat. No. 6,651,443), and Kashler (U.S. Pat. No. 7,228,682).

In recent years a series of disclosures have presented a simpler ammonia-water absorption cycle for the turbine inlet air chilling application. The simpler cycle uses a vapor-liquid separator in lieu of the traditional costly and complex distillation column. DeVault (U.S. Pat. No. 5,555,738), Ranasinghe et al (U.S. Pat. No. 6,058,695), Chow et al (U.S. Pat. No. 6,170,263), Vakil et al (U.S. Pat. No. 6,173,563), and Lerner et al (US2002/0053196) have all disclosed this approach.

### DISCLOSURE OF INVENTION

In contrast, we have discovered (and here disclose) that for the combined cycle turbine inlet air chilling application, the “simple cycle” (without rectification column) is more of a detriment than a benefit. It degrades cycle performance (COP) so much that larger heat exchangers are required, more heat input is required, and also more heat rejection. In an application where waste heat is already in short supply, the “simple” cycle exacerbates the difficulties. Also, in air-cooled cycles or where cooling water is in short supply, the added heat rejection is problematic. Hence one key aspect of the present disclosure is that a distillation column that reduces the water content of the vapor sent to the condenser to below about 3% (e.g. approximately 1.5%) be included in the absorption chilling cycle. For the same reasons, additional state-of-art performance enhancing measures are preferably included in the absorption cycle, such as “absorber heat exchange (ARK)” and “generator-absorber heat exchange (GAX)”

A substantial amount of the absorption refrigeration driving heat is extracted from the LP Economizer section of the HRSG. That is made possible by two features. Taking for example the case of a three pressure reheat combined cycle on a design 95 F day: first the exhaust is further cooled, to e.g. 177 F vs 196 F. The second feature that allows recovery of more useful exhaust heat into the absorption unit is to use reject heat from one of the absorbers of the absorption unit to preheat the feedwater by at least about 25 F, e.g. from 104 F to 148 F. With many fuels, including natural gas, that is hot enough to be above the acid dewpoint. Recirculating feedwater provides low temperature driving heat to the absorption refrigeration unit, while being cooled to approximately 20 to 35 F below the final exhaust temperature, e.g. to about 157 F. Then it is joined by fresh preheated (148 F) feedwater and pumped again into the LP economizer.

Supplying low temperature exhaust heat to the absorption unit in the above manner has the benefit that there is no decrease in steam flow whatsoever, and hence no reduction in steam turbine power output that offsets part of the gain from chilling.

The heat extraction from the exhaust can be alternatively to an ammonia-water solution heat exchanger (heat recovery vapor generator) in lieu of to recirculating feedwater. In that case the HRVG should be “interspersed” with the LP economizer, as described below, in lieu of “below” it (i.e. at lower temperature).

Higher temperature heat is also input to absorption refrigeration unit when necessary, i.e. on hotter days, as follows. The hot end of the LP Evaporator is converted to a heater, and a circulating pump circulates LP evaporator water through that heater, heating it by about 40 to 60 F, e.g. from 304 F to 356 F. It gives up high temperature heat to the absorption refrigeration unit, and then returns to the LP Evaporator at reduced temperature, e.g. 316 F. At the design 95 F ambient, this diversion of exhaust heat to the absorption unit causes a roughly 50% reduction in LP steam flow from this HRSG. On colder days, a bypass valve is controllably opened, bypassing a controllable portion of the hot water around the absorption unit, so there is less or no reduction in LP steam flow.

Inputting higher temperature exhaust heat to the absorption unit in this manner has the benefit that there is no decrease in HP steam flow or IP steam flow in the bottoming cycle, and hence the decrease in steam turbine power output is held to an absolute minimum. Just as with lower temperature exhaust heat input, the higher temperature input (above LP evaporator temperature) can also be via interspersed HRVG in lieu of by recirculating feedwater. Here the HRVG would preferably be located between the LP evaporator and the IP economizer.

Interspersing can be accomplished directly, either in parallel or in series. It can also be accomplished indirectly, via feedwater heating and using recirculating heated feedwater to heat the absorption cycle. Interspersing has the effect of providing higher temperature heat to the absorption cycle, with no detriment to the feedwater heating. There are two advantages to having higher input temperature. First, the feedwater preheat from the absorber can be to a higher temperature, thus freeing up more exhaust heat for the AAR. Second, there can be more internal heat recuperation in the absorber, thus raising COP and decreasing the required amount of heat input for a given amount of chilling.

The above examples all recite a combined cycle. However it will be recognized that this disclosure applies to any combustion turbine cycle incorporating a HRSG, e.g a cogeneration cycle, a STIG or Cheng cycle, etc. All of these have very little remaining “useful” exhaust heat in the conventional sense, and hence can benefit from the disclosed techniques of enhanced heat extraction in order to provide turbine inlet air chilling with little or no parasitic power penalty.

Another advantage of the disclosed inlet air chilling apparatus is that it can readily be adapted to provide inlet air anti-icing on cold days, with no added parasitic power. Conventional anti-icing systems entail an appreciable addition of parasitic power.

### BRIEF DESCRIPTION OF THE DRAWINGS, AND BEST MODE FOR CARRYING OUT THE INVENTION

FIG. 1 is a schematic flowsheet of a combustion turbine combined cycle power plant, comprised of a combustion turbine, a two pressure HRSG, plus a steam turbine and condenser. The compressor of the combustion turbine is fitted with a TIAC to chill the inlet air. The chilling is provided by an ammonia absorption refrigeration (AAR) apparatus, that is powered by exhaust heat at the cold end of the HRSG. Two heat streams are input to the AAR, one from an IP HRVG at the coldest end of the HRSG, and the other hotter input (in the LP economizer temperature range) from a HP HRVG that is interspersed in series with the LP economizer. The feedwater to the LP economizer is first preheated in the LP absorber of the AAR, thus making substantially more exhaust heat available to the two HRVGs. The preheat also raises the feedwater temperature above the acid dewpoint temperature. The feed preheat absorber is a second LP absorber at higher temperature, where the first LP absorber rejects heat to ambient cooling, e.g. cooling water or air. The AAR incorporates a third (intermediate) pressure level, to accommodate the low temperature heat input from the IP HRVG. The AAR includes a distillation column that purifies the ammonia vapor received from the HP HRVG before it is sent to the condenser. The distillation column incorporates diabatic rectification (solution cooled rectification) from the HP pump solution, and also diabatic reboiling (generator heat exchange) from the bottoms liquid. As illustrated, with the two pressure steam bottoming cycles there is usually enough waste heat in the exhaust, after accounting for the feedwater preheat (to at least 125 F), that there need be no detriment to the steam output from the bottoming cycle in order to power the AAR.

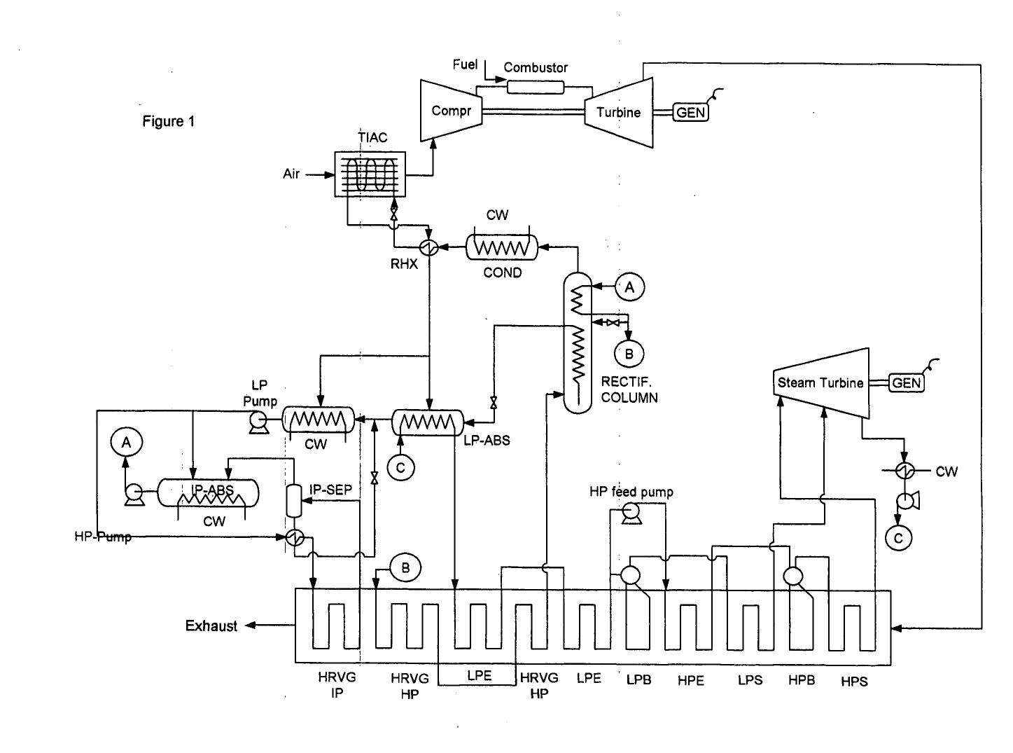

FIG. 2 illustrates an alternative AAR flowsheet for the combustion turbine inlet air chilling application. The quantities depicted are representative of a LM 6000 gas turbine. In this instance there is only a single HRVG that is in parallel interspersement with the LP economizer (vs series in FIG. 1). The feedwater is preheated, e.g. to 152 F, and the distillation column is diabatic (non-adiabatic). The distillation column bottoms reboil is from a once-thru solution heater (the HRVG), as opposed to a conventional kettle reboiler. This flow sheet is made more efficient by taking advantage of extra temperature availability of the heat input in parallel configuration, e.g. heating the aqueous ammonia solution up to 290 F. That extra temperature enables incorporating the “GAX” component (generator-absorber heat exchange). It is noteworthy that with this flowsheet the GAX improvement can be achieved with only waste heat, i.e. without any steam consumption.

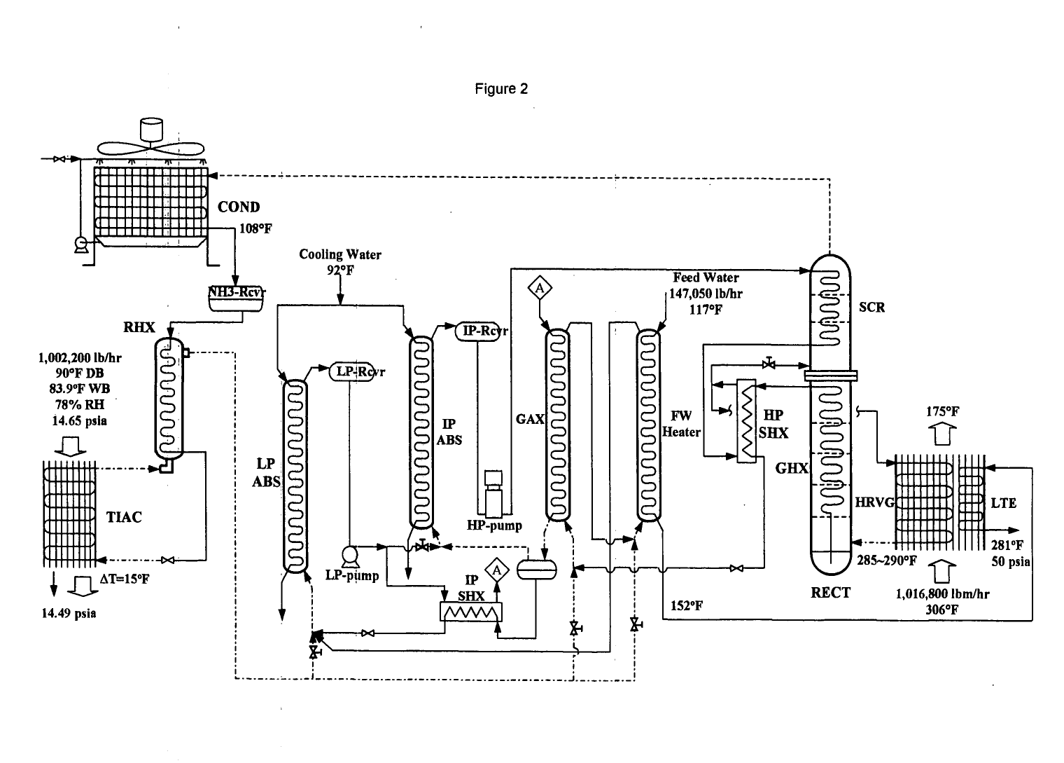

FIG. 3 illustrates another method of integrating an exhaust heat powered AAR with a combustion turbine having a HRSG so as to supply inlet air chilling. The quantities depicted are representative of a 7 FA gas turbine. In this embodiment the inlet air is chilled in two stages in series, cooling it from 76.2 F wet bulb temperature to 50 F, using 5799 tons of refrigeration. The AAR (aka ARU) has two heat inputs—one from a parallel interspersed LT HRVG, and the other from a HT HRVG that is parallel interspersed with the IP economizer. Once again, feedwater is preheated by the AAR, in this example from 104 F to 145 F. In this flowsheet the HT HRVG solution is heated directly by the exhaust.

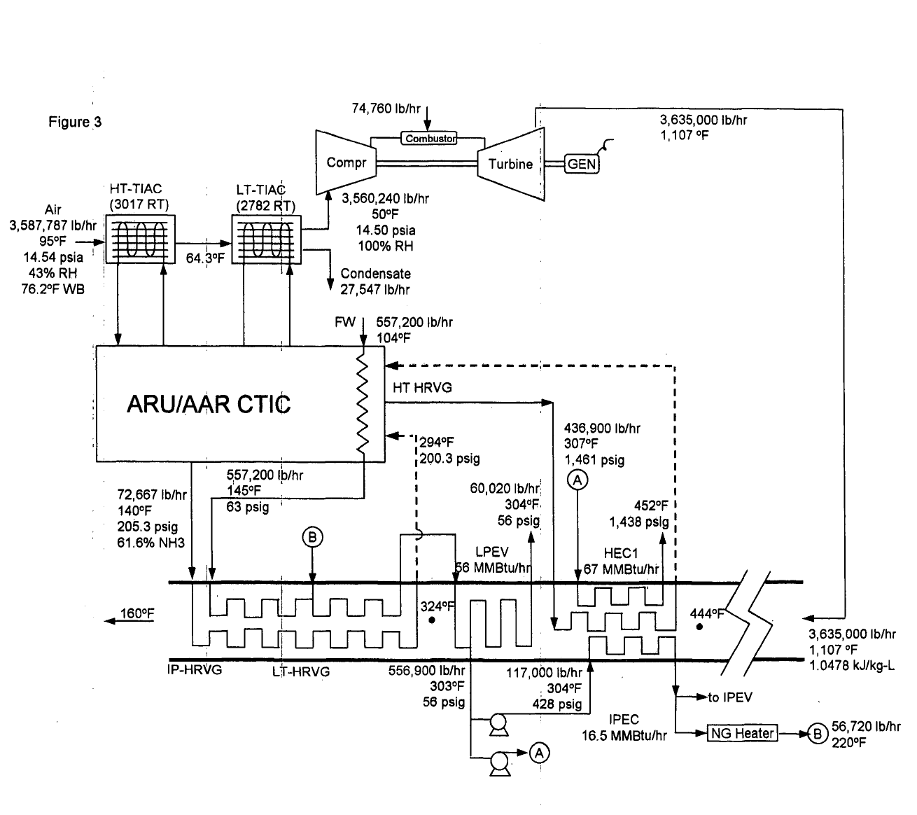

FIG. 4 illustrates yet another configuration for integrating an exhaust heat powered AAR with a combustion turbine having a HRSG so as to supply inlet air chilling. In this flowsheet, there are three stages of DX chilling, thus supplying ammonia vapor at three different pressures back to the AAR. Also, the high temperature heat input to the AAR is via either LP steam or recirculating feedwater.

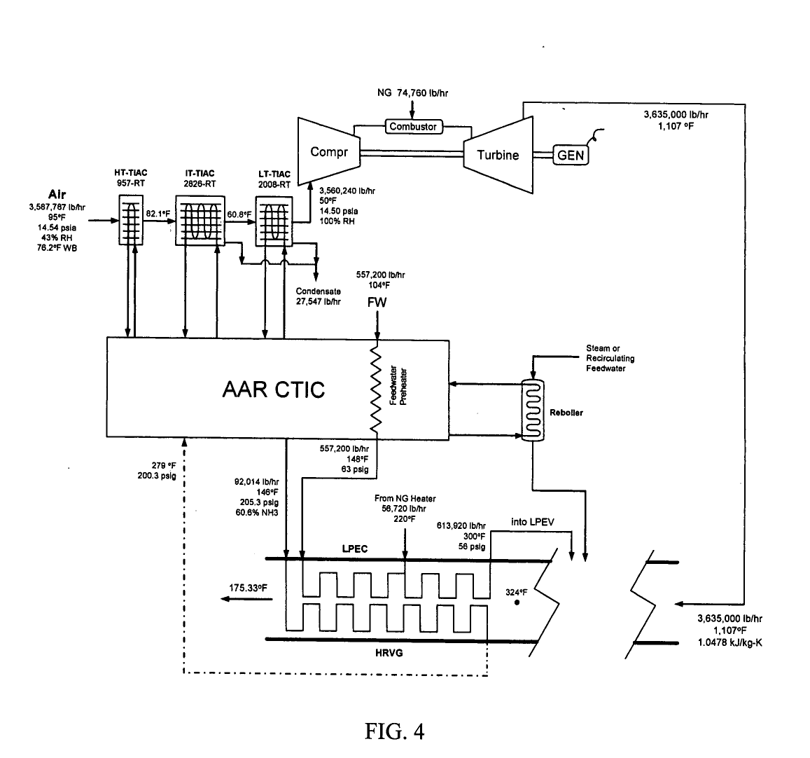

FIG. 5 provides a detail of the heat input portion of an AAR that provides inlet air cooling to a combustion turbine with HRSG, e.g. a 7 FA gas turbine in this example. The quantities depicted are representative of a 2×1 combined cycle plant, with a separate HRSG for each gas turbine, but only a single shared steam turbine. The lower temperature portion of one of the HRSGs is depicted, including the modifications necessary to supply two levels of heat to the AAR, both via recirculating feedwater. Thus two recirculating pumps are necessary. The first recirculates 157 F feedwater back to the LP economizer, after it has supplied low temperature heat to the AAR CTIC (combustion turbine inlet chiller). The second recirculation pump pumps 303 F water from the LP evaporator through a new heater, heating it to e.g. 356 F, and then supplies high temperature input to the AAR CTIC. Supplying high temperature input in this manner has the effect of decreasing the amount of LP steam that can be produced, whereas it has the benefit that the supplied temperature is appreciably above the temperature of the LP steam. In order to minimize the decreased amount of LP steam, a bypass valve is provided as shown, whereby any unneeded heat input from the recirculated stream can be recycled to the LP evaporator, where it ends up as LP steam.

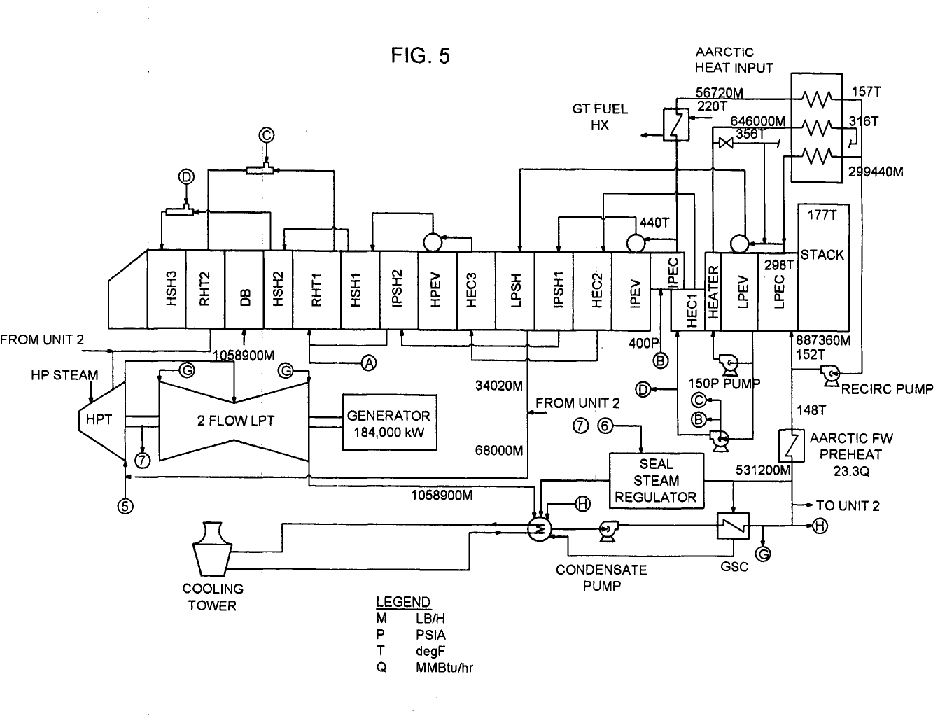

FIGS. 6a, 6b, and 6c illustrate details of the AAR flowsheet that could be applied to any of the FIG. 3, 4, or 5 configurations, with slight modifications. The quantities represent typical values for inlet air chilling of a 7 FA gas turbine. FIG. 6a depicts the ammonia vapor condensing section and the DX chilling section of the AAR cycle, with three sequential chilling stages, all three supplied from a common source of ammonia refrigerant, and each stage sending a different ammonia vapor pressure to the remainder of the cycle.

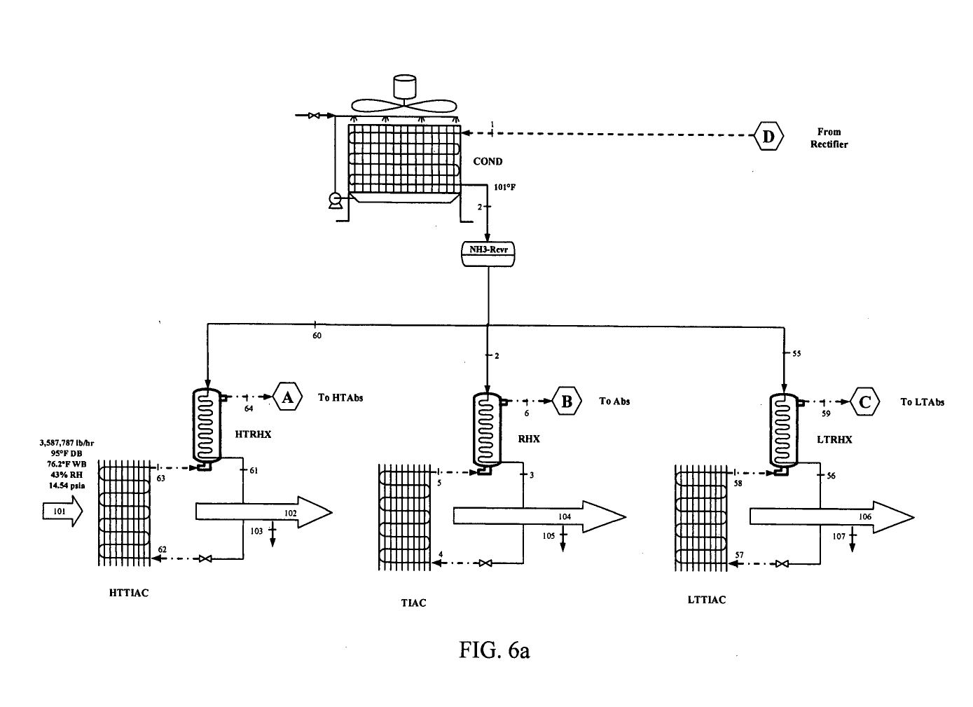

FIG. 6b depicts the heat input portion of the AAR, including the distillation column. Low temperature heat is input at the HRVG, and high temperature heat at the reboiler, e.g. from recirculating feedwater or steam. Note that, as shown here, one advantage of having multiple evaporators is that cool reflux streams G and E become available, such that no internal SCR heat exchange is required in the rectification column.

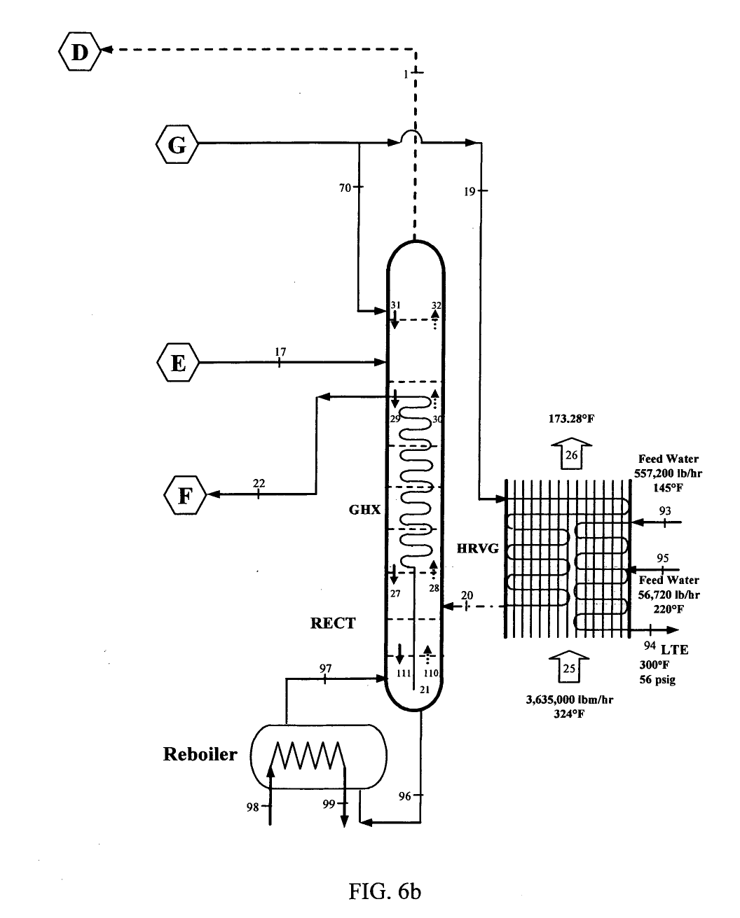

FIG. 6c depicts the remainder of the AAR cycle. The highest pressure ammonia vapor is absorbed into a solitary HT absorber, cooled by heat rejection to ambient (i.e. cooling water or air cooling). The lowest pressure ammonia vapor is absorbed into three absorbers at approximately the same temperature levels—the LT AHX, the FW preheater, and the HP AHX, and also into a lower temperature ambient cooled absorber.

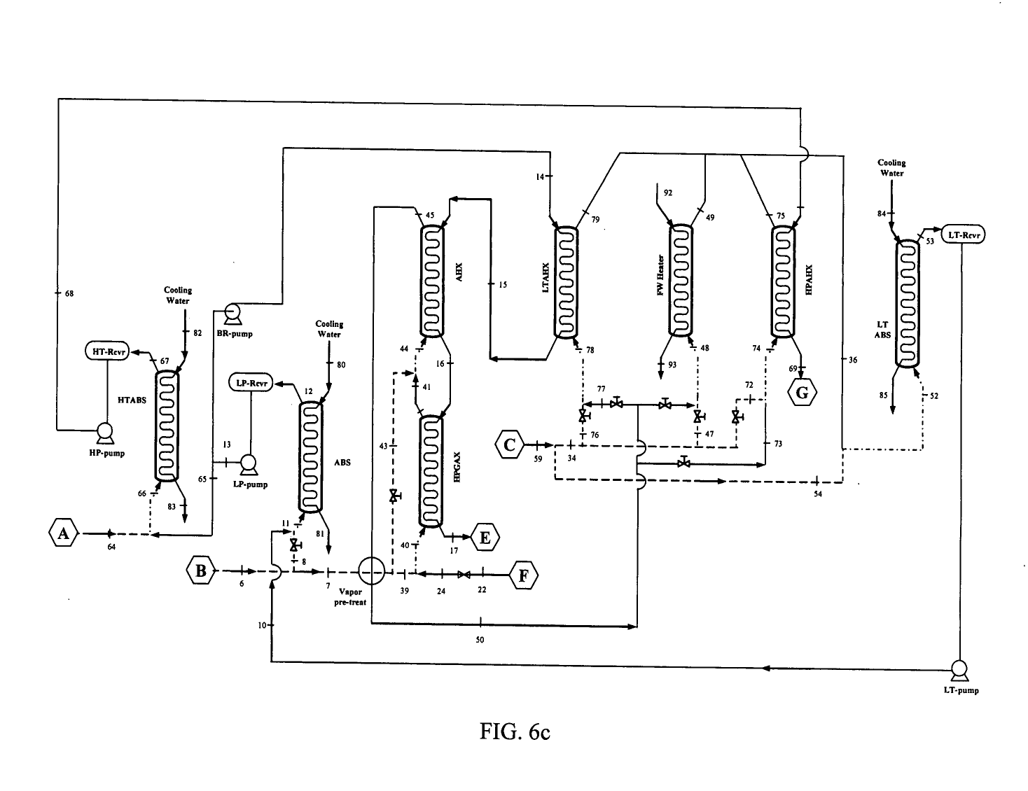

Note that the three at the same temperature all provide useful heat recovery. Finally, the intermediate pressure ammonia vapor is absorbed into three sequential absorbers, the first cooled by ambient, and the second (AHX) (warmer) and third (HP GAX) providing useful internal heat recuperation. FIG. 6c also depicts the solution pumps necessary to circulate the ammonia-water solution among the several components of the AAR cycle.

FIG. 6d depicts how the FIG. 6a flowsheet can be adapted to using chilled water for chilling the inlet air, in lieu of DX ammonia. The chilled water would be sequentially chilled in the three ammonia evaporators.

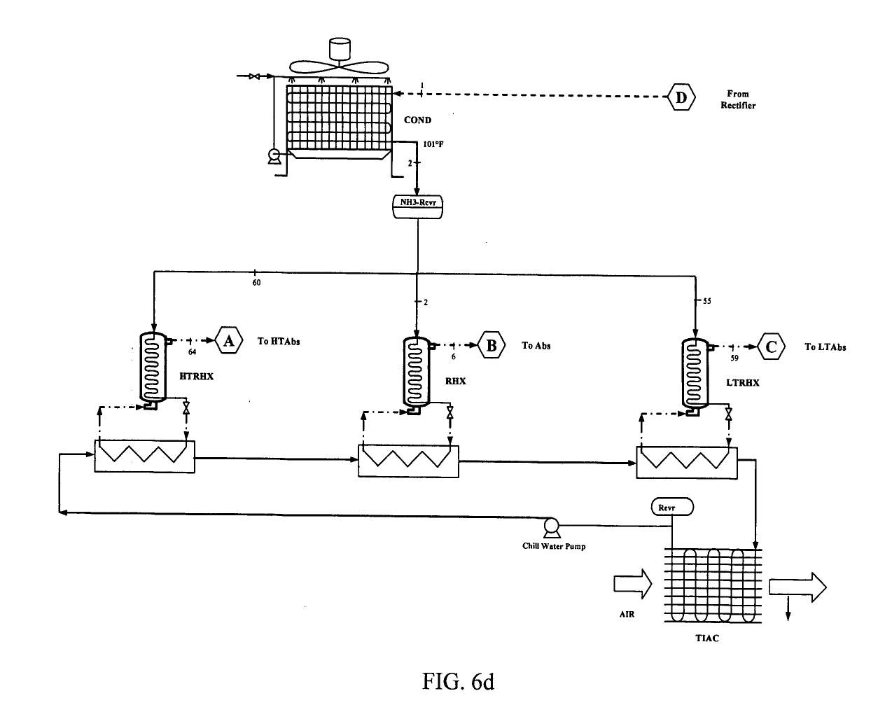

FIG. 7 illustrates the thermodynamic relationships of the FIG. 6 AAR cycle. In particular, the temperature, pressure, and concentration of the ammonia water working fluid is depicted throughout the cycle. Also shown are all the major heat exchanges, both internal to the cycle and between the cycle and the remainder of the combustion turbine power plant.

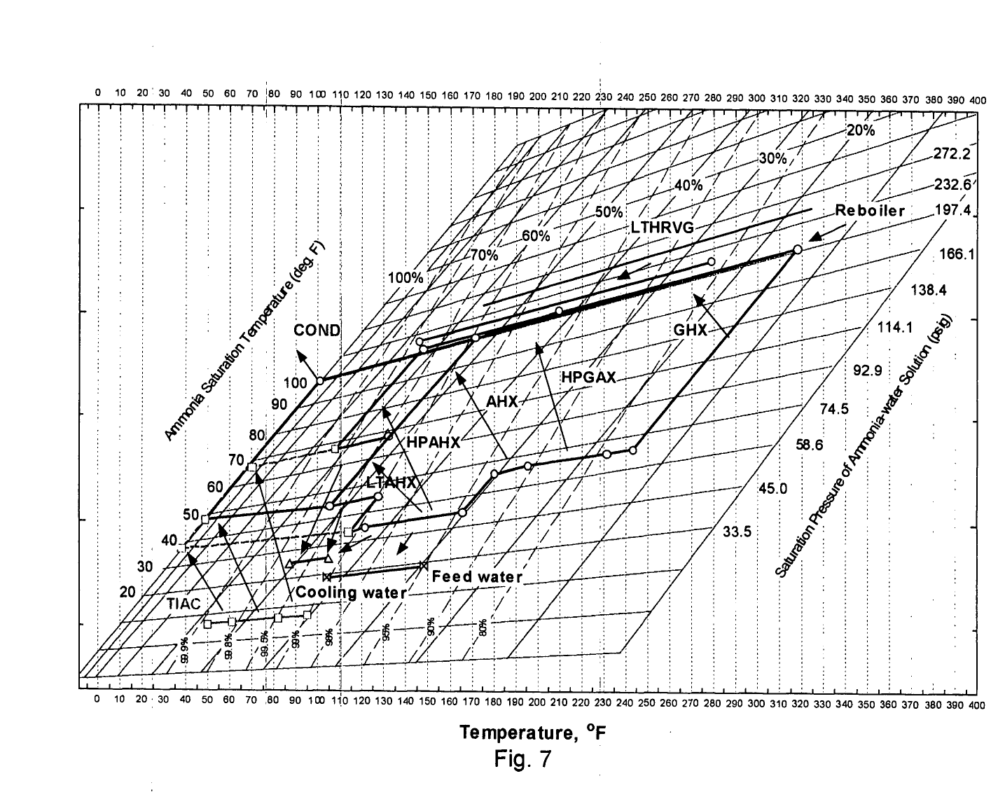

FIG. 8 is a modification of the FIG. 1 flowsheet, illustrating several additional features that may be individually advantageous in particular applications. First, the chilling cycle is air-cooled—condensation directly in a fin-fan air cooled concenser, and the two ambient heat rejection absorbers cooled via aqua solution that is cooled in fin-fans. Secondly, there is a second higher temperature, higher pressure stage of evaporation/chilling, that makes use of the already present IP absorber. Third, there is an anti-icing valve that converts the higher temperature air chilling coil to an air heating coil. Finally, there is an absorption power cycle, that makes power from the pressure energy in the high pressure ammonia vapor when it is not needed for chilling.

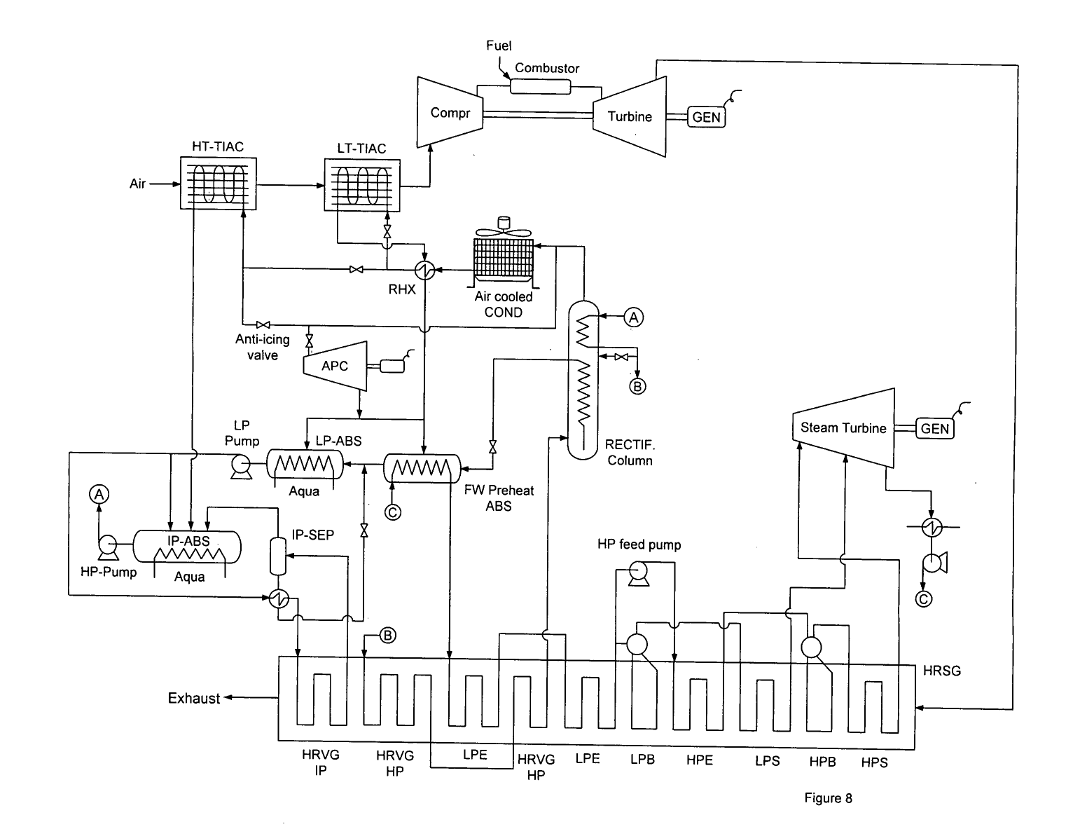

The AAR cycle variants disclosed for this application have several advantages. For example, given the ability of the AAR to be powered by low grade heat, below 300 F and as low as 170 F, there will frequently be opportunities to utilize what would otherwise be considered as waste heat from opportunity sources. One example would be from a cooler for the turbine blade cooling air. Another example would be from an associated fuel gasification plant, for example a plant used to produce synthesis gas for the gas turbine. In the same manner, there will frequently be opportunities for supplying some of the chilling to other beneficial uses. Examples would be, to use some of it for interchilling air between compression stages (intercooled cycle), or for recovery of water from the exhaust by additional cooling of the exhaust. All such enhancements are possible with the disclosed AAR cycle.

As an order-of-magnitude example of the power plant benefits possible with the disclosed apparatus, consider a 2×1 7 FA combined cycle. On a design hot day of 95 F DB, 77 F WB, it produces 460 MW without inlet chilling. When the disclosed inlet chilling is added (12,000 tons to chill both turbines to 50 F), the output is increased to 515 MW. This is at least 5 MW greater increase in capacity than possible from any other known inlet chilling technology, and also at appreciably higher energy efficiency. The comparison to conventional chilling technology is even more favorable when air cooling is used.

As a result of the disclosed internal heat recuperation and feedwater preheating in these AAR cycles, the amount of absorption heat that must be rejected to ambient is reduced to around half as much as ordinarily would be required. This translates directly to water savings in the case of water cooling, or parasitic fan power savings in the case of air cooling.

1. An inlet air chilling system for a combustion turbine power plant having a heat recovery steam generator that is heated by turbine exhaust, comprising:
a. an ammonia absorption refrigeration apparatus that is supplied activation heat from said exhaust, wherein:
i. part of said activation heat is at a temperature above the boiling temperature of the lowest pressure steam produced in said HRSG;
ii. a remaining part of said activation heat is at a temperature below the boiling temperature of said lowest pressure steam; and
b. said AAR apparatus is comprised of at least two absorbers that absorb ammonia vapor at different pressures from two evaporators at different temperatures.

2. The apparatus according to claim 1 wherein said turbine inlet air is supplied sequentially to said two evaporators for sequential chilling therein by direct expansion, and said AAR apparatus is comprised of at least one additional absorber that absorbs ammonia vapor at one of said pressures, and that rejects heat to feedwater for said HRSG.

3. The apparatus according to claim 1 wherein said AAR apparatus is additionally comprised of a rectification column that reduces the H₂O content of the generated vapor to less than about 2%.

4. The apparatus according to claim 3 wherein bottom liquid from said column is withdrawn through internal heat exchange apparatus, supplying heat to said column and cooling to said liquid.

5. An ammonia-water absorption refrigeration apparatus that is adapted to chill the inlet air to a power plant comprised of a combustion turbine plus a heat recovery steam generator, said absorption refrigeration system comprised of:
a. at least one evaporator that supplies chilling for said air by evaporating liquid ammonia refrigerant to vapor;
b. at least one absorber for part of said vapor, said absorber being cooled by heat rejection to an ambient cooled fluid;
c. an additional absorber for another part of said vapor that rejects heat of absorption to feedwater for said HRSG, whereby said feedwater is heated above 125 F;
d. at least one desorber that is heated either directly or indirectly by the exhaust from said turbine; and
e. a distillation column for the vapor desorbed from said desorber.

6. The absorption refrigeration apparatus according to claim 5 additionally comprised of: a second evaporator and at least one additional absorber that receives vapor from said second evaporator.

7. An ammonia-water absorption refrigeration apparatus that is adapted to chill the inlet air to a power plant comprised of a combustion turbine plus a heat recovery steam generator, said absorption refrigeration system comprised of:
a. at least two desorbers;
b. a means for inputting heat to each of said desorbers by any of:
i. locating the desorber in the HRSG, whereby it is directly heated by exhaust;
ii. supplying steam from said HRSG to said desorber;
iii. supplying feedwater to said desorber that is heated in and recirculated to said HRSG; and
c. a distillation column for the vapor desorbed from said desorbers.

8. The absorption refrigeration apparatus according to claim 7 additionally comprised of: an absorber that is cooled by feedwater for said HRSG.

9. An ammonia-water absorption refrigeration apparatus that is adapted to chill the inlet air to a power plant comprised of a combustion turbine plus a heat recovery steam generator, said absorption refrigeration system comprised of:
a. at least two evaporators at different temperatures and pressures;
b. an absorber for each evaporator, each absorber having ambient heat rejection;
c. a sequential flowpath of said air through said evaporators in order of decreasing temperature and pressure.

10. The absorption refrigeration apparatus according to claim 9 additionally comprised of: a second absorber for each evaporator, wherein at least one of said second absorbers is cooled by HRSG feedwater, and another is cooled by absorbent solution.

11. The absorption refrigeration apparatus according to claim 9 additionally comprised of a control valve for supplying vapor to one of said evaporators, thus enabling it to provide heating via condensation.

12. An ammonia-water absorption refrigeration apparatus that is adapted to chill the inlet air to a power plant comprised of a combustion turbine plus a heat recovery steam generator, said absorption refrigeration system comprised of:
a. at least two evaporators at different temperatures and pressures;
b. a chill water loop that is cooled sequentially by said evaporators;
c. an inlet air chilling coil that is supplied said chill water;
d. at least one absorber for each evaporator pressure; and
e. a means for supplying combustion turbine exhaust heat to said apparatus.

13. The apparatus according to claim 12 additionally comprised of a rectification column and a feedwater preheater comprised of one of said absorbers.

14. An ammonia-water absorption refrigeration apparatus that is adapted to chill the inlet air to a power plant comprised of a combustion turbine plus a heat recovery steam generator, said absorption refrigeration system comprised of:
a. a heat input system for said absorption apparatus comprised of a pumped loop that circulates feedwater between said absorption apparatus and a Low Pressure economizer in said HRSG; and
b. an absorber that rejects heat to the water fed into said feedwater system.

15. The absorption refrigeration apparatus according to claim 14 additionally comprised of: a second heat input system for said apparatus comprised of a second pumped loop comprised of a heat exchanger in the HRSG in the IP economizer temperature region; said absorption apparatus; and a discharge path back to the LP evaporator.

16. The absorption refrigeration apparatus according to claim 15 additionally comprised of a controllable bypass valve in the second heat input system around said absorption apparatus.

17. An ammonia-water absorption refrigeration apparatus that is adapted to chill the inlet air to a power plant comprised of a combustion turbine plus a heat recovery steam generator, said absorption refrigeration system comprised of:
a. a pumped liquid recirculation loop that transfers heat from the exhaust from said turbine to the absorbent solution of said apparatus;
b. a rectification column that purifies the ammonia vapor produced from the application of said heat to said absorbent solution; and
c. a vapor absorber that transfers heat of absorption to the feedwater for said HRSG.

18. The apparatus according to claim 17 additionally comprising:
a. a steam boiler in said HRSG that is the source of said pumped liquid; and
b. a bypass valve in said pumped loop that bypasses the pumped liquid to said boiler.

19. The apparatus according to claim 6 additionally comprised of at least one of:
a. an anti-icing valve that supplies heating vapor to one of said evaporators;
b. an absorption power cycle that produces power from otherwise unused HP vapor;
c. an internal heat recuperation device (AHX and/or GAX); and
d. air-cooled heat rejection to ambient.

20. A process for chilling inlet air to a power plant comprised of a combustion turbine plus a HRSG, comprising:
a. powering an ammonia absorption refrigeration apparatus with exhaust heat from said combustion turbine;
b. providing said chilling from said AAR; and
c. heating HRSG feedwater to at least 125 F from heat rejected from said AAR.
